(19) United States
(12) Patent Application Publication
(10) Pub. No.: US 2011/0115906 A1
(43) Pub. Date: May 19, 2011

(54) MONITORING SYSTEM AND CONTROL METHOD THEREOF

(75) Inventors: Chun-Hsu Su, Taipei City (TW); Ren-Peng Chen, Taipei (TW)

(73) Assignee: AMROAD TECHNOLOGY, INC., Taipei County (TW)

(21) Appl. No.: 12/619,679

(22) Filed: Nov. 17, 2009

(51) Int. Cl. H04N 7/18

(52) U.S. Cl. 348/143

(57) ABSTRACT

The present invention discloses an improved monitoring system and a control method thereof. After a visitor operates an input unit of the improved monitoring system and triggers a driving unit, an image capturing module is driven to capture a still image of the visitor and simultaneously a warning module is driven to send out a prompting message. Subsequently, the still image is stored in a storage unit and transmitted to an internal communication device. If a host makes a response within a certain time period, the host can talk with the visitor and get a dynamic image of the visitor from the internal communication device. If the host has no response to the system within a certain time period, the still image is then transmitted to an assigned external communication device.

### BACKGROUND OF THE INVENTION

(a) Field of the Invention

The present invention provides an improved monitoring system and a control method thereof, and more particularly relates to an improved monitoring system in which a monitoring system captures still images of visitors by using an image capturing module so that a host can preview the still images of visitors and previously determines the identities of visitors and a control method thereof.

(b) Description of the Prior Art

Nowadays, the demand of people for quality of life is increasingly growing, and especially the comfort and convenience of the inhabited environment are indispensable factors. With the fast development of technologies, many inventions facilitating the comfort and convenience of the inhabited environment are proposed by applying technologies, and a door intercom is one of them. The most original door intercoms can only transmit sound messages, and conversation with visitors is made through a door intercom disposed on an outer side of the door. However, the images of visitors cannot be directly viewed for identification, so there is a lot of improvement space in the safety of door audio intercoms.

Accordingly, prior inventors had devoted to the research and improvement on the above problem, and thus proposed a video door intercom architecture which can simultaneously transmit the sounds and images of visitors to enhance resident safety. Referring to FIG. 1, there is shown a schematic view of a video door intercom architecture of the prior art. The video door intercom architecture A comprises a video door intercom A1 and an in-house receiver A2. The video door intercom A1 further comprises an image pickup device A11, a door end intercom device A12 and a doorbell device A13. The in-house receiver A2 further comprises an image display device A21 and a receiving intercom device A22. When a visitor stands at an appropriate position and presses the doorbell device A13, the doorbell device A13 will ring to notify the host. After the host actuates the image pickup device A11, the image pickup device A11 captures a dynamic image of the visitor. The dynamic image is transmitted via a line to the in-house receiver A2 and displayed on the image display A21. The host and the visitor can respectively use the door end intercom device A12 and the receiving intercom device A22 to talk with each other. The identity and purpose of the visitor can be simultaneously confirmed by the transmitted images and sounds so as to decide whether to open the door or not. However, the video door intercom architecture A of the prior art only provides one-to-one audio/video transmission namely the audio/video transmission between a video door intercom A1 fixedly disposed on an outer side of the door and an in-house receiver A2 fixedly disposed in the room. Because the in-house receiver A2 is disposed at a fixed position, the host must only move to a specific position every time to actuate the video door intercom architecture A. It is indeed inconvenient is use.

Therefore, prior inventors proposed an improved video door intercom architecture as disclosed in Taiwan Patent Application No. 094218661 “video door intercom device” that has been published and granted by the Taiwan Intellectual Property Office (TIPO) with respect to the above drawbacks. Referring to FIG. 2, there is shown a schematic view of an improved video door intercom architecture of the prior art. The improved video door intercom architecture B comprises a video door intercom B1, a telecommunication switching device B2 and a plurality of in-house receivers B3, B4 and B5. The video door intercom B1 further comprises an image pickup device B11, a door end intercom device B12 and a doorbell device B13. The plurality of in-house receivers B3, B4 and B5 further comprise image displays B31, B41 and B51 and receiving intercom devices B32, B42 and B52 respectively. The principle of the improved video door intercom architecture B is the same as that of the video door intercom architecture A, and in the difference is that the improved video door intercom architecture B captures dynamic images and sounds of a visitor, and subsequently transmits the dynamic images and sounds to the telecommunication switching device B2. The dynamic images and sounds are simultaneously transmitted through the telecommunication switching device B2 to the plurality of receivers B3, B4 and B5. The plurality of receivers B3, B4 and B5 can be disposed at arbitrary sites in the room to increase the convenience in use; they can be further disposed in a company, a vehicle or a portable videophone such that the host can talk with the visitor and receive the dynamic images of the visitor even if the host is not at home. Although the improved video door intercom architecture B offers more convenience in use, it still has certain drawbacks that need to be overcome. The host must actuate the improved video door intercom architecture B to identify the visitor after the visitor is arrival. Hence, unexpected visitors cannot be filtered out. If the images of visitors can be previewed, the drawback can then be overcome.

### SUMMARY OF THE INVENTION

In view of the above problems and drawbacks, as a result of continued trials and modifications, the inventors herein propose an improved monitoring system based on their experience accumulated for many years with imagination and creativity.

A first objective of the present invention is to provide an improved monitoring system to enhance resident safety, that is when a visitor operates an input unit of the monitoring system and triggers a driving unit, at least one image capturing module is driven to capture at least one still image of the visitor. The host can preview the still image of the visitor, and identify the visitor before conversation, and then decides whether to make a response or not so as to filter out unexpected visitors.

A second objective of the present invention is to provide an improved monitoring system for the host talking with the host in time, that is, when the host goes out, the improved monitoring system transmits the still images of the visitors to an external communication device. After the host has determined the identity of the visitor, the host can further talk with the visitor via the external communication device, even manage the entrance guard.

A third objective of the present invention is to provide an improved monitoring system for a later response while the host cannot talk to the visitor immediately, that is, when the host goes out, the improved monitoring system transmits the still image of the visitor to the external communication device. If the host could not make a response in time, the external communication device would retain the still image of the visitor and record the time of visit so as to let the host treat subsequent affairs concerned later.

A fourth objective of the present invention is to provide an improved monitoring system for the host identifying input information from the host, that is, the system comprises a display unit, which is disposed on a door end operating device. After the visitor operates an input unit, the input information is displayed on the display unit for the host to confirm whether the input information is correct or not.

A fifth objective of the present invention is to provide an improved monitoring system for responding a message from the host to notify the host in time, that is, the display unit disposed on the door end operating device is able to appear a message from the host to notify the visitor when the host goes out or has no response to the system.

To achieve the aforementioned objectives, the invention provides an improved monitoring system comprising: at least one image capturing module, which is disposed at a first appropriate position on an outer side of a door for taking at least one still image and at least one dynamic image of a visitor; at least one warning module, which is disposed at a second appropriate position in a room for sending out a prompting message; a door end intercom module, which is disposed at a third appropriate position on the outer side of the door for talking with the visitor by a host; a door end operating device, which is disposed at a fourth appropriate position on the outer side of the door and further comprises: an input unit, which is provided for the visitor to input a number of a room where the host is located or a specific number; a display unit, which is able to display the usage status of the monitoring system; and a driving unit, which is provided for the visitor to trigger and drive the image capturing module and the warning module; at least one storage unit, which is used for storing the still image and the dynamic image taken by the image capturing module; at least one internal communication device, which is disposed at a fifth appropriate position in a room and comprises: a first image display, which is used for display the still image and the dynamic image taken by the image capturing module; a first receiving intercom module, which is provided for the host to talk with the visitor; and a security module, which is provided for the host to control the entrance of the visitor; and at least one external communication device, which further comprises: a second image display, which is able to receive the still image and the dynamic image transmitted by the storage unit; and a second receiving intercom module, which is provided for the user of the external communication device to talk with the visitor and the host.

The invention further provides a control method for an improved monitoring system comprising the steps of: (1) start; (2) a visitor standing still in front of the improved monitoring system; (3) operating an input unit by the visitor, displaying the input on a display unit; (4) triggering a driving unit by the visitor; (5) driving at lest one image capturing module by the driving unit to take at least one still image of the visitor, driving a warning module to send out a message to notify a host; (6) transmitting the still image from the image capturing module to a storage unit for storing; (7) transmitting the still image from the storage unit to an internal communication device and displaying them on a first image display; (8) the improved monitoring system determining that the host makes a response within a certain time period, if yes, going to step (9), otherwise, going to step (11); (9) switching the mode for the still image to a mode for dynamic images, the host and the visitor then talking with each other via intercom modules, going to step (10); (10) processing a security operation for safety by the host, going to step (12); (11) transmitting the still image to a external communication device and displaying the visit time and related information, going to step (12); and (12) end.

### BRIEF DESCRIPTION OF THE DRAWINGS

FIG. 1 is a schematic view of a video door intercom architecture of the first prior art;

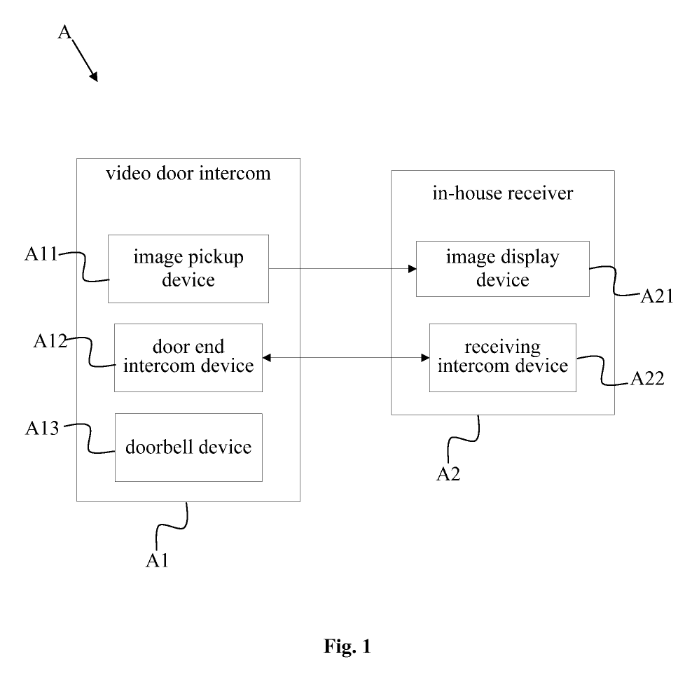

FIG. 2 is a schematic view of an improved video door intercom architecture of the second prior art;

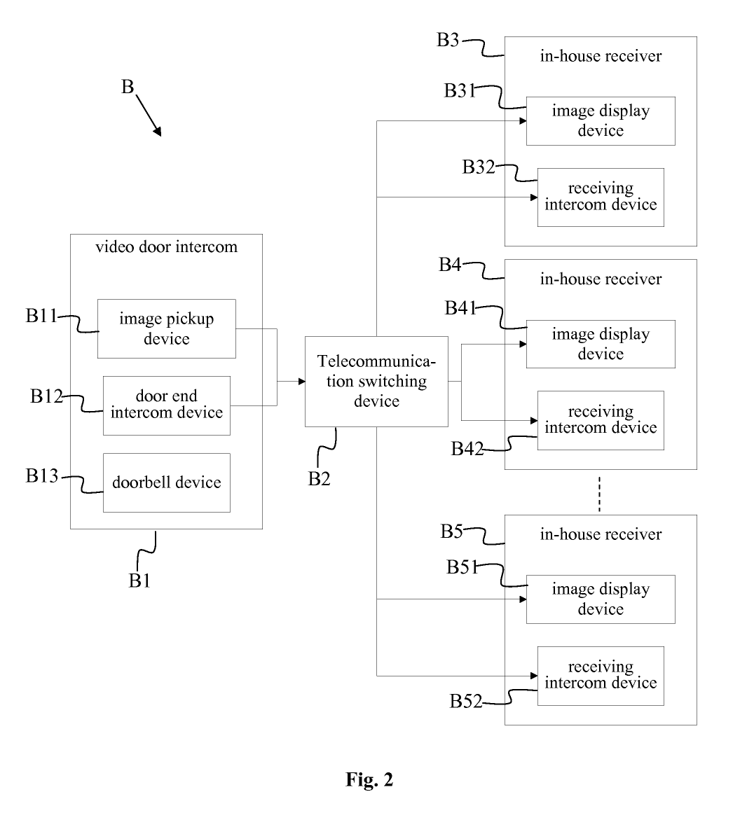

FIG. 3 is an architectural diagram of an improved monitoring system of a first preferred embodiment according to the present invention;

FIG. 4 is a flow chart for controlling an improved monitoring system of a first preferred embodiment according to the present invention;

FIG. 5 is an architectural diagram of an improved monitoring system of a second preferred embodiment according to the present invention;

FIG. 6 is an architectural diagram of an improved monitoring system of a third preferred embodiment according to the present invention; and

FIG. 7 is an architectural diagram of an improved monitoring system of a fourth preferred embodiment according to the present invention.

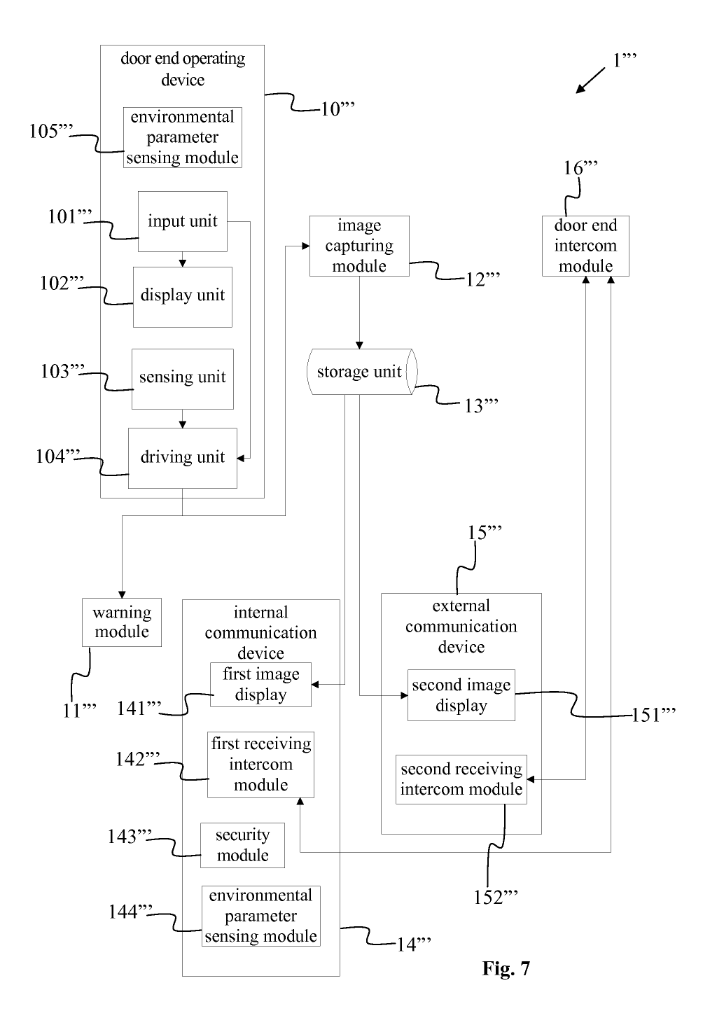

### DETAILED DESCRIPTION OF THE PREFERRED EMBODIMENTS

To achieve the foregoing objectives and effects, the inventors incorporate the still image capture technique into a video door intercom of the prior art and make improvements and modifications to the intercom, thus achieving the improved monitoring system and its control method of the present invention. The system architectures and control methods of the present invention are now illustrated in reference to an architectural diagram of an improved monitoring system of a first preferred embodiment according to the present invention, a flow chart for controlling an improved monitoring system of the first preferred embodiment, an architectural diagram of an improved monitoring system of a second preferred embodiment, an architectural diagram of an improved monitoring system of a third preferred embodiment, and an architectural diagram of an improved monitoring system of a fourth preferred embodiment.

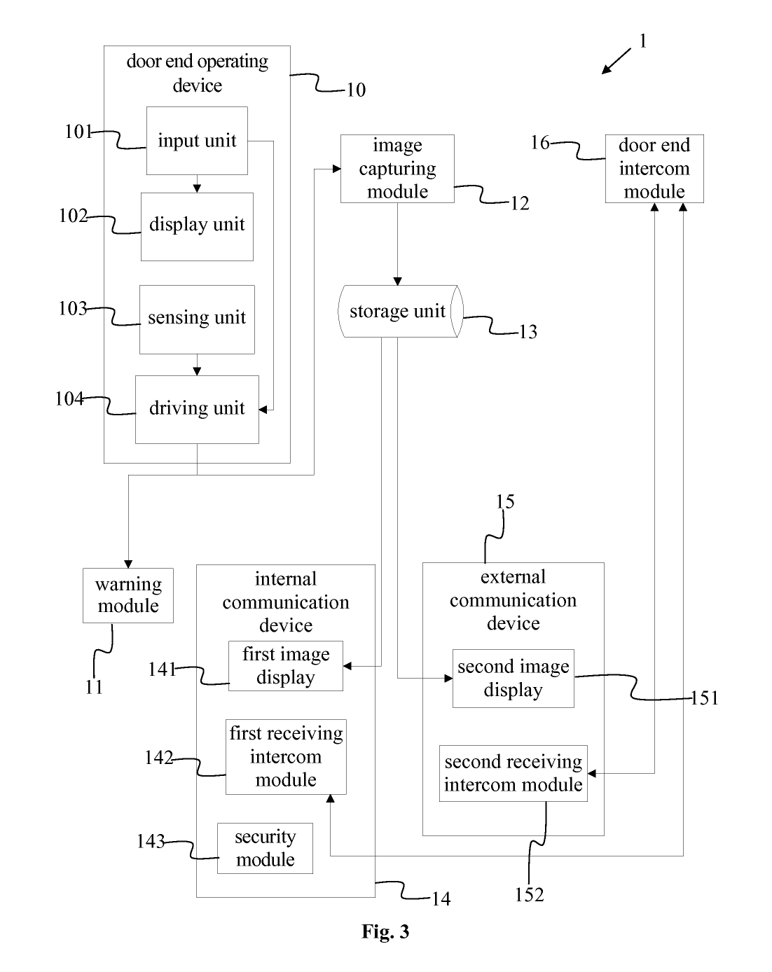

Referring to FIG. 3, which is shown an architectural diagram of an improved monitoring system of a first preferred embodiment according to the present invention. The improved monitoring system 1 comprises a image capturing module 12, a warning module 11, a door end intercom module 16, a door end operating device 10, a storage unit 13, a internal communication device 14, and a external communication device 15.

The image capturing module 12 is disposed at a first appropriate position on an outer side of a door for taking a still image and a dynamic image of a visitor, and the image capturing module 12 comprises a lens for adjusting the capturing angle of the lens to ensure the integrity of the still images and dynamic images.

The warning module 11 is disposed at a second appropriate position in a room for sending out a prompting message such as sounds, light signals or images.

The door end intercom module 16 is disposed at a third appropriate position on the outer side of the door and provided for a host to talk with the visitor.

The door end operating device 10 is disposed at a fourth appropriate position on the outer side of the door and further comprises an input unit 101, a display unit 102, a driving unit 104, and a sensing unit 103. The input unit 101 is provided for the visitor to input a number of a room where the host is located or a specific number. The display unit 102 is able to display the usage status of the monitoring system 1. The driving unit 104 is provided for the visitor to trigger and drive the image capturing module 12 and the warning module 11. The sensing unit 103 can receive specific signals to control the entrance of the visitor or actuate the driving unit 104. The aforementioned image capturing module 12 and the door end intercom module 16 are disposed on the door end operating device 10.

The storage unit 13 is used for storing the still image and the dynamic image taken by the image capturing module 12.

The internal communication 14 device can be a videophone or a personal home computer and is disposed at a fifth appropriate position in a room. The internal communication device 14 further comprises a first image display 141, a first receiving intercom module 142 and a security module 143. The first image display 141 is used for displaying the still image and the dynamic image taken by the image capturing module 12. The first receiving intercom module 142 is provided for the host to talk with the visitor. The security module 143 is provided for the host to control the entrance of the visitor.

The external communication device 15 can be a portable videophone, a company computer or a vehicle communication device and further comprises a second image display 151 and a second receiving intercom module 152. The second image display 151 is able to receive the still image and the dynamic image transmitted by the storage unit 13. The second receiving intercom module 152 is provided for the user of the external communication device 15 to talk with the visitor and the host.

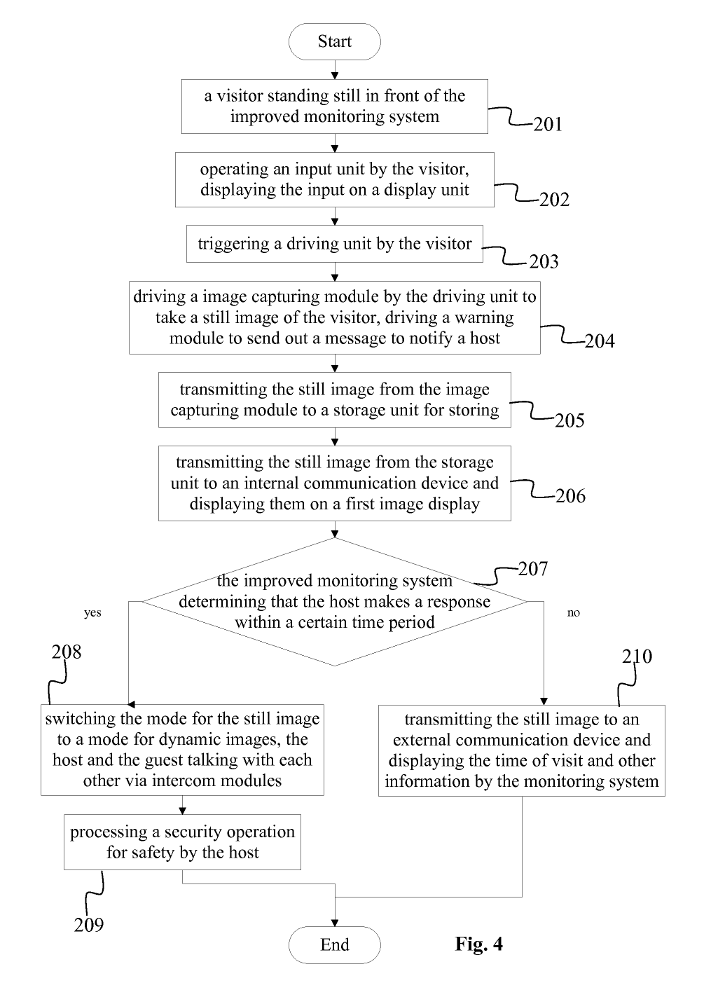

Referring to FIG. 4, which is shown a flow chart for controlling the improved monitoring system of a first preferred embodiment according to the present invention. A control method for the improved monitoring system 1 comprises the following steps: the visitor standing still in front of the improved monitoring system 1 (step 201); operating the input unit 101 by the visitor, displaying the input on the display unit 102 (step 202); triggering the driving unit 104 by the visitor (step 203); driving the image capturing module 12 by the driving unit 104 to take a still image of the visitor, driving the warning module 11 to send out a message to notify the host (step 204), wherein the warning module 11 is separately or simultaneously able to send out the messages of sounds, light signals or images; transmitting the still image from the image capturing module 12 to the storage unit 13 for storing (step 205); transmitting the still image from the storage unit 13 to the internal communication device 14 and displaying them on the first image display 141 (step 206), wherein the internal communication device 14 is a videophone or a personal home computer; the improved monitoring system 1 determining that the host makes a response within a certain time period (step 207), if yes, going to step 208, otherwise, going to step 210, wherein the certain time period is 30 seconds; switching the mode for the still image to a mode for dynamic images, the host and the visitor then talking with each other via intercom modules (step 208), then going to step 209; processing a security operation for safety by the host (step 209), then ending the method; and transmitting the still image to the external communication device 15 by the monitoring system 1 and displaying the time of visit and other information (step 210), then ending the method, wherein the external communication device 15 can be a portable videophone, a company computer or a vehicle communication device.

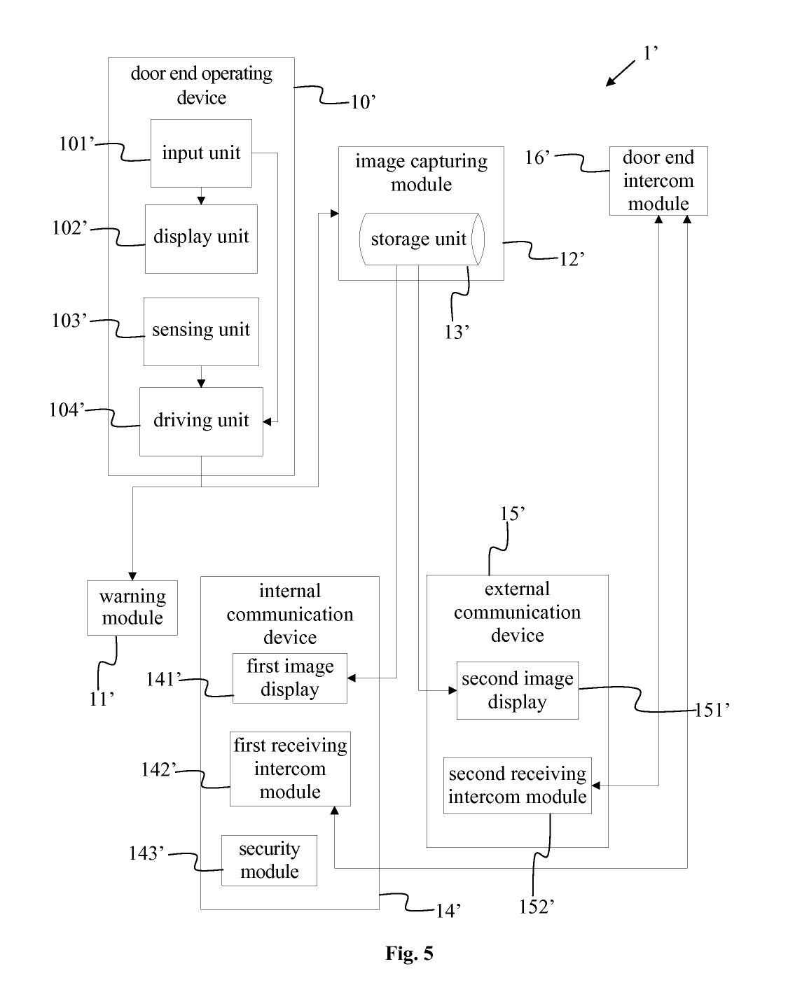

Next, referring to FIG. 5, there is shown an architectural diagram of an improved monitoring system of a second preferred embodiment according to the present invention. The improved monitoring system 1′ of the second preferred embodiment is substantially the same as the improved monitoring system 1 of the first preferred embodiment, and their difference is that a storage unit 13′ of the improved monitoring system 1′ of the second preferred embodiment is not an independent unit and disposed in a image capturing module 12′. After the image capturing module 12′ has captured a still image of the visitor, the still image is immediately stored in the storage unit 13′ and transmitted to an internal communication device 14′ or an external communication device 15′ via a line or a telecommunication system for executing the subsequent actions.

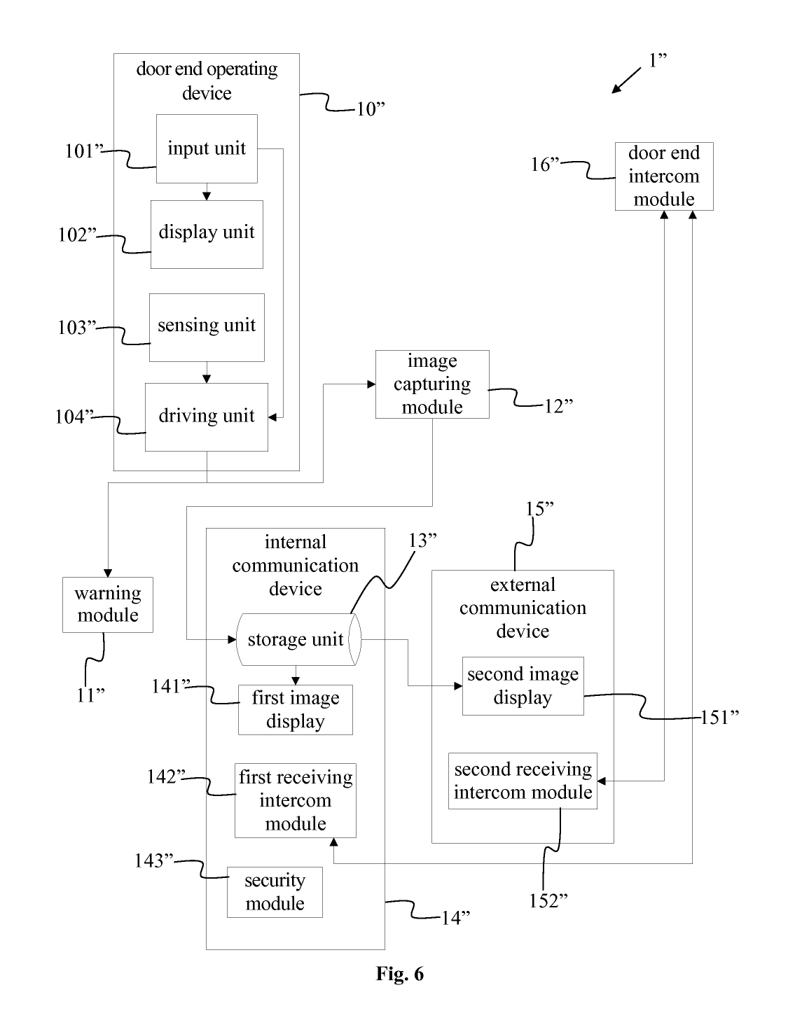

Next, referring to FIG. 6, there is shown an architectural diagram of an improved monitoring system of a third preferred embodiment according to the present invention. The improved monitoring system 1″ of the third preferred embodiment is substantially the same as the improved monitoring system 1 of the first preferred embodiment, and their difference is that a storage unit 13″ of the improved monitoring system 1′ of the third preferred embodiment is not an independent unit and disposed in an internal communication device 14″. After a image capturing module 12″ has captured at least one still image of the visitor, the still image is transmitted via a line to and stored in the storage unit 13″ and then can be displayed on a first image display 141″ of the internal communication device 14″, or otherwise be transmitted via a telecommunication system to an external communication device 15″ and displayed on a second image display 151″ for executing the subsequent actions.

Next, referring to FIG. 6, there is shown an architectural diagram of an improved monitoring system of a fourth preferred embodiment according to the present invention. The improved monitoring system 1′ of the fourth preferred embodiment is substantially the same as the improved monitoring system 1 of the first preferred embodiment, and their difference is that a door end operating device 10″′ and a internal communication device 14″′ of the improved monitoring system 1′ both further comprise a environmental parameter sensing module 105″′ and 144″′ for detecting particular environmental parameters, such as temperature, humidity, atmospheric pressure, light, value of carbon dioxide, or value of noise, and displaying the results on a display unit 102″′ of the door end operating device 10″′ and a first image display 141″′ of the internal communication device 14″′.

In the above first, second, third, and fourth preferred embodiments, the unit structures included in the door end operating devices 10, 10′, 10″, and 10″′ can be adjusted according to the purposes or the scale of the building where the host is located. For example, the door end operating devices 10, 10′, 10″, and 10″′ do not have the display units 102, 102′, 102″, and 102″′ thereon; or the door end operating devices 10, 10′, 10″, and 10″′ are not disposed thereon with the input units 101, 101′, 101″, and 101″′ and are only disposed with one or more driving units 104, 104′, 104″, and 104″′. The driving units 104, 104′, 104″, and 104″′ are connected to the internal communication devices 14, 14′, 14″, and 14″′ and the warning modules 11, 11′, 11″, and 11′ of specific hosts.

In the above first, second, third, and fourth preferred embodiments, the door end operating device 10, 10′, 10″, and 10″′, the image capturing modules 12, 12′, 12″, and 12″′ as well as the door end intercom modules 16, 16′, 16″, and 16″′ can be respectively disposed at appropriate positions on an outer side of the door. The image capturing modules 12, 12′, 12″, and 12″′ and the door end intercom modules 16, 16′, 16″, and 16″′ can also be disposed on the door end operating devices 10, 10′, 10″, and 10″′ to form integrated devices.

The improved monitoring system and its control method of the present invention have the advantages as below:
1. When a visitor triggers a driving unit of the monitoring system, at least one image capturing module is driven to capture at least one still image of the visitor. The host can preview the still images of the visitor, and therefore can identify the visitor before conversation and then decides whether to make a response or not so as to filter out unexpected visitors and enhance resident safety.
2. If the host goes out, the monitoring system will transmit the still images of the visitor to an external communication device such that the host at another location can get the identity and associated messages of the visitor.
3. In addition to displaying the messages inputted by the visitor while operating the input unit, if the host has no response, the display unit disposed on the door end operating device can display this message to the visitor so as to avoid the long wait of the visitor.

It should be understood that the embodiments of the present invention described herein are merely illustrative of the technical concepts and features of the present invention and are not meant to limit the scope of the invention. Those skilled in the art, after reading the present disclosure, will know how to practice the invention. Various variations or modifications can be made without departing from the spirit of the invention. All such equivalent variations and modifications are intended to be included within the scope of the invention.

As a result of continued thinking about the invention and modifications, the inventors finally work out the designs of the present invention that has many advantages as described above. The present invention meets the requirements for an invention patent, and the application for a patent is duly filed accordingly. It is expected that the invention could be examined at an early date and granted so as to protect the rights of the inventors.

What is claimed is:

1. An improved monitoring system comprising:
at least one image capturing module, which is disposed at a first appropriate position on an outer side of a door for taking at least one still image and at least one dynamic image of a visitor;
at least one warning module, which is disposed at a second appropriate position in a room for sending out a prompting message;
a door end intercom module, which is disposed at a third appropriate position on the outer side of the door and provided for a host to talk with the visitor;
a door end operating device, which is disposed at a fourth appropriate position on the outer side of the door and further comprises:
an input unit, which is provided for the visitor to input a number of a room where the host is located or a specific number;
a display unit, which is able to display the usage status of the monitoring system; and
a driving unit, which is provided for the visitor to trigger and drive the image capturing module and the warning module;
at least one storage unit, which is used for storing the still image and the dynamic image taken by the image capturing module; and
at least one internal communication device, which is disposed at a fifth appropriate position in a room and comprises:
a first image display, which is used for displaying the still image and the dynamic image taken by the image capturing module;
a first receiving intercom module, which is provided for the host to talk with the visitor; and
a security module, which is provided for the host to control the entrance of the visitor.

2. The improved monitoring system as claimed in claim 1, wherein the image capturing module comprises at least one lens, which can adjust the capturing angle of the lens to ensure the integrity of the images.

3. The improved monitoring system as claimed in claim 1, wherein the internal communication device is selected from the group of: a videophone and a personal home computer.

4. The improved monitoring system as claimed in claim 1, wherein the warning module is separately or simultaneously able to send out the following message group consisted of: sounds, light signals and images.

5. The improved monitoring system as claimed in claim 1, wherein the door end operating device further comprises a sensing unit for receiving specific signals to control the entrance of the visitor or actuate the driving unit.

6. The improved monitoring system as claimed in claim 1, wherein the image capturing module and the door end intercom module are disposed on the door end operating device.

7. The improved monitoring system as claimed in claim 1, wherein the improved monitoring system further contains at least one external communication device, which comprises:
a second image display, which is able to receive the still image and the dynamic image transmitted by the storage unit; and
a second receiving intercom module, which is provided for the user of the external communication device to talk with the visitor and the host.

8. The improved monitoring system as claimed in claim 7, wherein the external communication device is selected from the group consisted of: a portable videophone, a company computer and a vehicle communication device.

9. The improved monitoring system as claimed in claim 1, wherein the door end operating device further comprises a environmental parameter sensing module for detecting particular environmental parameters and displaying the results on the first image display of the internal communication device.

10. The improved monitoring system as claimed in claim 9, wherein the environmental parameter sensing module is able to detect the following environmental parameter group consisted of: temperature, humidity, atmospheric pressure, light, value of carbon dioxide, and value of noise.

11. The improved monitoring system as claimed in claim 1, wherein the improved monitoring system further comprises a environmental parameter sensing module disposed at a sixth appropriate position in a room for detecting particular environmental parameters and displaying the results on the first image display of the internal communication device.

12. The improved monitoring system as claimed in claim 11, wherein the environmental parameter sensing module is able to detect the following environmental parameter group consisted of: temperature, humidity, atmospheric pressure, light, value of carbon dioxide, and value of noise.

13. An improved monitoring system comprising:
at least one image capturing module, which is disposed at a first appropriate position on an outer side of a door for taking at least one still image and at least one dynamic image of a visitor;
at least one warning module, which is disposed at a second appropriate position in a room for sending out a prompting message;
a door end intercom module, which is disposed at a third appropriate position on the outer side of the door and provided for a host to talk with the visitor;
a door end operating device, which is disposed at a fourth appropriate position on the outer side of the door and further comprises:
an input unit, which is provided for the visitor to input a number of a room where the host is located or a specific number;
a display unit, which is able to display the usage status of the monitoring system; and
a driving unit, which is provided for the visitor to trigger and drive the image capturing module and the warning module;
at least one storage unit, which is used for storing the still image and the dynamic image taken by the image capturing module;
at least one internal communication device, which is disposed at a fifth appropriate position in a room and comprises:
a first image display, which is used for display the still image and the dynamic image taken by the image capturing module;
a first receiving intercom module, which is provided for the host to talk with the visitor; and
a security module, which is provided for the host to control the entrance of the visitor; and
at least one external communication device, which further comprises:
a second image display, which is able to receive the still image and the dynamic image transmitted by the storage unit; and
a second receiving intercom module, which is provided for the user of the external communication device to talk with the visitor and the host.

14. The improved monitoring system as claimed in claim 13, wherein the image capturing module comprises at least one lens, which can adjust the capturing angle of the lens to ensure the integrity of the still image and dynamic images.

15. The improved monitoring system as claimed in claim 13, wherein the storage unit is an independent unit.

16. The improved monitoring system as claimed in claim 13, wherein the storage unit is disposed in one of the following group consisted of: the image capturing module and the internal communication device.

17. The improved monitoring system as claimed in claim 13, wherein the internal communication device is selected from the group consisted of: a videophone and a personal home computer.

18. The improved monitoring system as claimed in claim 13, wherein the external communication device is selected from the group consisted of: a portable videophone, a company computer and a vehicle communication device.

19. The improved monitoring system as claimed in claim 13, wherein the warning module is separately or simultaneously able to send out the following message group consisted of: sounds, light signals and images.

20. The improved monitoring system as claimed in claim 13, wherein the door end operating device further comprises a sensing unit for receiving specific signals to allow the entrance of the visitor or actuate the driving unit.

21. The improved monitoring system as claimed in claim 13, wherein the image capturing module and the door end intercom module are disposed on the door end operating device.

22. The improved monitoring system as claimed in claim 13, wherein the door end operating device further comprises a environmental parameter sensing module for detecting particular environmental parameters and displaying the results on the first image display of the internal communication device.

23. The improved monitoring system as claimed in claim 22, wherein the environmental parameter sensing module is able to detect the following environmental parameter group consisted of: temperature, humidity, atmospheric pressure, light, value of carbon dioxide, and value of noise.

24. The improved monitoring system as claimed in claim 13, wherein the improved monitoring system further comprises a environmental parameter sensing module disposed at a sixth appropriate position in a room for detecting particular environmental parameters and displaying the results on the first image display of the internal communication device.

25. The improved monitoring system as claimed in claim 24, wherein the environmental parameter sensing module is able to detect the following environmental parameter group consisted of: temperature, humidity, atmospheric pressure, light, value of carbon dioxide, and value of noise.

26. A control method for an improved monitoring system comprising the steps of:
(1) start;
(2) a visitor standing still in front of the improved monitoring system;
(3) operating an input unit by the visitor, displaying the input on a display unit;
(4) triggering a driving unit by the visitor;
(5) driving at lest one image capturing module by the driving unit to take at least one still image of the visitor, driving a warning module to send out a message to notify a host;
(6) transmitting the still image from the image capturing module to a storage unit for storing;
(7) transmitting the still image from the storage unit to an internal communication device and displaying them on a first image display;
(8) the improved monitoring system determining that the host makes a response within a certain time period, if yes, going to step (9), otherwise, going to step (11);
(9) switching the mode for the still image to a mode for dynamic images, the host and the visitor then talking with each other via intercom modules, then going to step (10);
(10) processing a security operation for safety by the host, then going to step (12);
(11) transmitting the still image to a external communication device and displaying the time of visit and other information by the monitoring system, then going to step (12); and
(12) end.

27. The control method for an improved monitoring system as claimed in claim 26, wherein the internal communication device is selected from the group consisted of: a videophone and a personal home computer.

28. The control method for an improved monitoring system as claimed in claim 26, wherein the warning module is separately or simultaneously able to send out the following message group consisted of: sounds, light signals and images.

29. The control method for an improved monitoring system as claimed in claim 26, wherein the external communication device is selected from the group consisted of: a portable videophone, a company computer and a vehicle communication device.

30. The control method for an improved monitoring system as claimed in claim 26, wherein the certain time period according to step (8) is 30 seconds.
